(19) United States
(12) Patent Application Publication
(10) Pub. No.: US 2009/0008005 A1
(43) Pub. Date: Jan. 8, 2009

(54) PET CAGE COVER

(76) Inventor: Sammy Chu, Irvine, CA (US)

Correspondence Address: J.C. Patents, Suite 250, 4 Venture, Irvine, CA, 92618, US

(21) Appl. No.: 11/774,456

(22) Filed: Jul. 6, 2007

(51) Int. Cl. A01K 1/03

(52) U.S. Cl. 150/154

(57) ABSTRACT

A pet cage cover for covering a pet cage comprises a top panel and a plurality of side panels. The top panel and the side panels define a space for receiving the pet cage. Each of the side panels corresponds to one sidewall of the pet cage in shape and size and can be independently rolled up, so that all of the sidewalls of the pet cage can be exposed by the pet cage cover. Therefore, no matter on which sidewall the door or multiple doors of the pet cage are located, they can be always conveniently exposed by rolling up the corresponding side panel on the cage cover, so that the door or multiple doors are conveniently accessible even with the pet cage cover on. To provide desired covering function, each pair of adjacent side panels can be detachably connected along their side edges with, for example, a zipper or Velcro.

### BACKGROUND OF THE INVENTION

1. Field of the Invention

The present invention generally relates to a pet cage cover, and more particularly to a pet cage cover with individually foldable side panels.

2. Description of Related Art

Various pet cage covers are available on the market. However, those conventional pet cage covers usually have only one side that is accessible to the door of a pet cage. If the door is located at a different side or having multiple doors on different sides of the cage, the same cover would no longer be suitable for use for even the pet cage having the same size and shape because the door can not be conveniently accessed when the pet cage cover is on.

### SUMMARY OF THE INVENTION

The present invention is directed to a pet cage cover for covering a pet cage. The pet cage cover, according to the present invention comprises a top panel and a plurality of side panels. The top panel and the side panels define a space for covering the pet cage. Each of the side panels corresponds to one sidewall of the pet cage in shape and size and can be independently rolled up, so that all of the sidewalls of the pet cage can be exposed by the pet cage cover. Therefore, no matter on which sidewall the door or multiple doors of the pet cage are located, they can be always conveniently exposed by rolling up the corresponding side panel on the cage cover, so that the door or multiple doors are conveniently accessible even with the pet cage cover on. To provide desired covering function, each pair of adjacent side panels can be detachably connected along their side edges with, for example, a zipper or Velcro.

To hold the rolled up side panel or panels in position, a plurality of straps are provided. One end of the strap can be fixed on the inner surface of the top panel, or on other suitable locations, such as on the upper portion of the inner surface of the side panel near or at its upper edge. The strap is placed around the rolled up side panel and tightened to the top panel so as to keep the rolled up side panel in position. Velcro is provided on both ends of the strap so that they can be connected by the Velcro. Velcro also can be provided at other locations along the length of the strap, so that the height or position of the rolled up side panel can be adjusted by engaging with the Velcro on different locations on the strap.

A plurality of strap holders is provided on the outer surface of the top panel for receiving the straps. The strap holder can be made of an elongated piece of material with its two ends fixed on the outer surface of the top panel, defining a gap between the elongated piece and the outer surface of the top panel. In use, the strap is inserted through the gap and placed around the elongated piece of the strap holder. The strap holder also can be a button fixed on the outer surface of the top panel which engages a matching button or button hole provided on the strap.

### BRIEF DESCRIPTION OF THE DRAWINGS

The novel features and advantages of the present invention will become more apparent by describing in detail exemplary embodiments with reference to the attached drawings in which:

FIG. 1 is a perspective view of a pet cage cover according to one embodiment of the present invention.

FIG. 2 is an enlarged view of a topside corner of a pet cage cover according to one embodiment of the present invention, showing a strap holder on the top surface of the cage cover.

FIG. 3 is an enlarged view of an inner topside corner of a pet cage cover according to one embodiment of the present invention, showing a strap on the inner top surface of the cage cover.

### DETAILED DESCRIPTION OF THE EMBODIMENTS

The present invention will now be described with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

In the drawings, whenever the same element reappears in subsequent drawings, it is denoted by the same reference numeral.

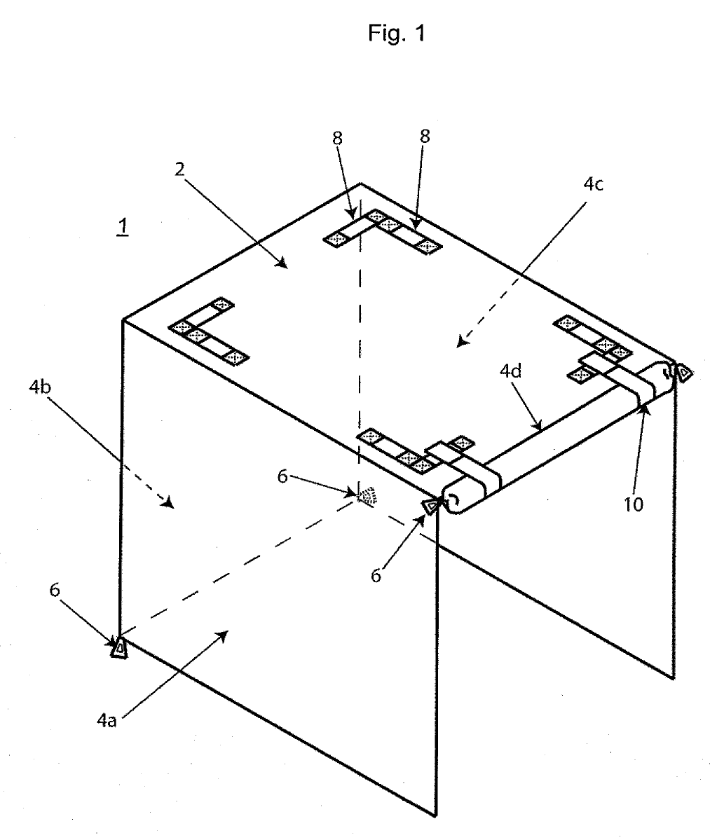

Referring to FIG. 1, FIG. 1 shows a pet cage cover 1 according to an embodiment of the present invention. Pet cage cover 1 has a top panel 2 and four side panels 4a, 4b, 4c, and 4d. When in use, pet cage cover 1 is placed on a pet cage (not shown) of a corresponding shape, with the top panel 2 covering the top surface of the pet cage and the four side panels 4a, 4b, 4c, and 4d covering the corresponding side surfaces of the pet cage. The pet cage cover of the present invention can be made of any suitable materials, such as fabric, leather, or synthetic materials. Different panels can be made of the same or different materials. In the embodiment as shown in FIG. 1, the pet cage cover 1 has four side panels and one top panel, suitable for a rectangular-parallelepiped-shaped pet cage having a top panel, a bottom panel, and four side panels. But, the pet cage cover can be made to be suitable for any other shapes of pet cages. For example, there can be more or less than four side panels, and the panel can be of any suitable shapes corresponding to that of the pet cage. Windows or other openings can be provided on the panels.

Each of panels 4a, 4b, 4c, and 4d is connected to one corresponding edge of top panel 2 at their upper edges, or top panel 2 and panels 4a, 4b, 4c, and 4d can be made of one piece of material. Zipper 6 is provided between each pair of side panels 4a, 4b, 4c, and 4d along the entire length of their side edges from bottom to top. When unzipped, each of side panels 4a, 4b, 4c, and 4d can be folded or rolled up (See panel 4d in FIG. 1), so as to expose one or more sides of the pet cage. If desirable, one side panel can be made from more than one piece of material and a zipper can be provided between different pieces, so that a selected portion of a side panel can be independently rolled up and the rest of the side panel remains in the covering position. The zipper can be any suitable conventional zipper. If desirable, male and female Velcro can also be used to detachably connect side panels.

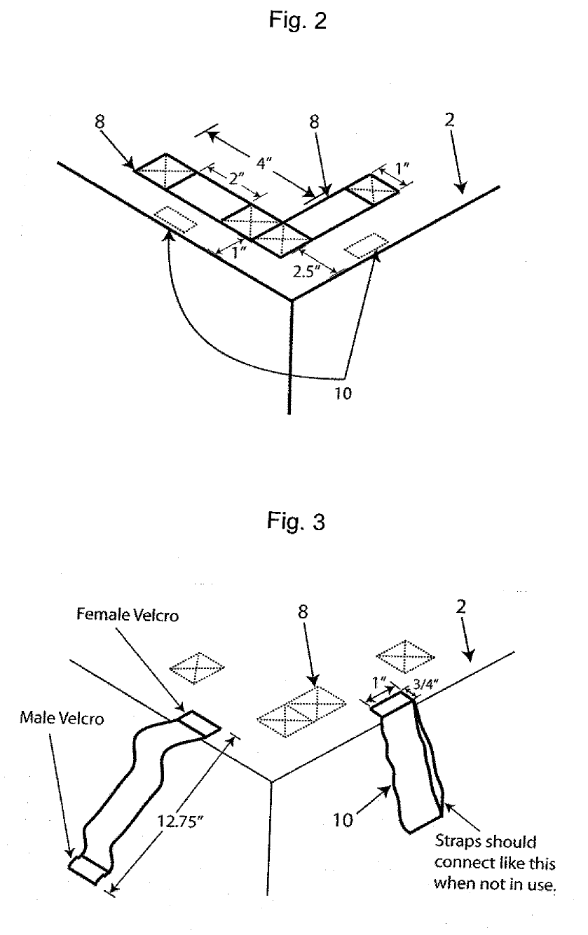

On top panel 2, strap holders 8 are provided for holding straps 10. In the embodiment shown in FIGS. 1 and 2, strap holder 8 is made of an elongated piece of material with its two ends fixed on the top panel 2, defining a gap between the elongated piece and the outer surface of top panel 2. The elongated piece can be made of a material as the same or different as that of top panel 2 and side panels 4a, 4b, 4c, and 4c. One end of strap 10 is fixed to the inner surface of top panel 2 in a position corresponding to the gap between the elongated piece and the outer surface of top panel 2 as shown in FIGS. 2 and 3. Both ends of strap 10 are provided with matching Velcro. When a side panel is rolled up, strap 10 is placed around the rolled-up side panel, the free end of strap 10 is inserted into the gap between the elongated piece and the outer surface of top panel 2 and placed around the elongated piece, and attached to the fixed end of strap 10 via the Velcro as shown in FIG. 1. In this way, the side panel is held in the rolled-up position by the strap 10. There are two strap holders 8 and two straps 10 for each side panel in the embodiment shown in FIG. 1. More or less than two straps and two strap holders can be used for one side panel. In order to adjust the height or position of the rolled-up side panel, multiple pieces of Velcro can be provided at different locations along the length of the strap 10, and the free end of strap 10 can be attached to any of these Velcro so as to hold the rolled-up side panel at a desired height. Alternatively, the strap holder 8 can be replaced with a Velcro and the strap 10 can be directly attached to the Velcro on outer surface of top panel 2. The strap holder 8 can also be replaced with a button, to which the free end of the strap can be attached via a corresponding button or button-matching-hole on the strap 10.

Optionally, a bottom panel (not shown in the Figs.) can be provided. The edges of the bottom panel can be detachably connected to the bottom edges of the side panels via, for example, zippers or Velcro.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pet cage cover for covering a pet cage having a top wall, a plurality of sidewalls, and one or more doors, comprising:
a top panel corresponding to the top wall of the pet cage in shape and size;
a plurality of side panels connected to the top panel at their upper edges, each of the side panels corresponding to one of the sidewalls of the pet cage in shape and size;
a plurality of strap holders provided on an outer surface of the top panel; and
a plurality of straps, one end of each of the straps being fixed on an inner surface of the top panel;
wherein each of side panels can be independently rolled up, the straps can be placed around corresponding rolled-up side panels to keep them in a rolled-up position by engaging with the strap holders.

2. The pet cage cover of claim 1, wherein the top panel and the side panels are made of the same material.

3. The pet cage cover of claim 1, wherein windows or other openings are formed on the side panels.

4. The pet cage cover of claim 1, wherein each pair of adjacent side panels is detachably connected with a zipper.

5. The pet cage cover of claim 1, wherein each pair of adjacent side panels is detachably connected with a Velcro.

6. The pet cage cover of claim 1, wherein the strap holder is made of an elongated piece of material with its two ends fixed on the outer surface of the top panel, defining a gap between the elongated piece and the outer surface of top panel.

7. The pet cage cover of claim 1, wherein the strap holder is a button fixed on the outer surface of the top panel.

8. The pet cage cover of claim 1, wherein the strap is provided with Velcro at predetermined locations.
